(19) United States
(12) Patent Application Publication
(10) Pub. No.: US 2005/0156012 A1
(43) Pub. Date: Jul. 21, 2005

(54) Method of soldering electrical connection

(76) Inventor: Ted Ju, Taipei (TW)

Correspondence Address: TED JU, P.O. BOX 26-757, TAIPEI, 106, TW

(21) Appl. No.: 10/759,962

(22) Filed: Jan. 16, 2004

(51) Int. Cl. B23K 31/02

(52) U.S. Cl. 228/180.1; 228/180.21; 228/245

(57) ABSTRACT

A method of soldering an electrical connection is described. A plurality of terminals is formed on an insulating casing, a plurality of slots being formed on a bottom of the insulating casing to communicate respectively with the terminals. A solder material is applied over electrical contacts of a circuit board for bonding the electrical connection to the circuit board, wherein the slots in the bottom of the insulating casing correspond to the solder material. The solder material is melted by heating, and the height of the solder material increases due to a cohesion effect so as to extend into the slots and bond to the terminals. The terminals need not contact the solder material before being soldered. Therefore, soldering quality is improved, while problems of short circuits and soldering failure due to deformation of the terminals are eliminated.

### BACKGROUND OF THE INVENTION

1. Field of the Invention

The invention relates to a method of soldering an electrical connection, and more particularly to a method of soldering terminals of an electrical connection on a circuit board.

2. Description of the Related Art

Electrical connection between terminals of an electrical connection and a circuit board is determined by soldering quality. The electrical connection works adequately only when each electrical contact is securely soldered on the circuit board.

Referring to FIG. 1, a conventional method of soldering an electrical connection includes applying a solder material (not shown) on electrical contacts of a circuit board 500; placing an electrical connection 100 on the electrical board 500; attaching an exposed soldering end 310 of each terminal 300 of an insulator 200 and a metallic sheet 400 of an electrical connection 100 onto the solder material; and bonding the soldering end 310 and the metallic sheet 400 to the circuit board 500 by heating.

In the above soldering method, the soldering end of the terminal and the metallic sheet of the electrical connection are suspended outside an insulating casing. After the terminals and the metallic sheet are bent, the flatness thereof is not controllable. Therefore, some of the-soldering ends of the terminals and the metallic sheet are not co-planar, resulting in soldering failure, especially when the numbers of terminals and metallic sheets are substantially high. Furthermore, the terminals may be accidentally deformed during production, packaging or transport of the electrical connection, causing short circuits or soldering failures.

### SUMMARY OF THE INVENTION

It is therefore an object of the invention to provide a method of soldering an electrical connection that ensures soldering quality of the electrical connection on a circuit board.

In order to achieve the above and other objectives, the method of soldering the electrical connection according to the invention includes:
1) forming a plurality of terminals on an insulating casing, the terminals transversally extending through to be exposed by the insulating casing, a plurality of slots being formed in a bottom of the insulating casing to communicate respectively with the terminals;
2) applying a solder material over electrical contacts of the circuit board to bond the electrical connection to the circuit board, in which the slots on the bottom of the insulating casing correspond to the solder material; and
3) melting the solder material by heating, wherein the height of the solder material increases due to a cohesion effect so as to extend into the slots and bond to the terminals.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of a conventional method of soldering an electrical connection onto a circuit board;

FIG. 2 is a bottom view of an electrical connection according to a first embodiment of the invention;

FIG. 3 is a cross-sectional view illustrating an electrical connection before being soldered onto a circuit board according to a first embodiment of the invention;

FIG. 4 is a cross-sectional view illustrating an electrical connection after being soldered onto a circuit board according to a first embodiment of the invention;

FIG. 5 is a cross-sectional view of an electrical connection with another type of terminals before the electrical connection is soldered onto a circuit board according to a first embodiment of the invention;

FIG. 6 is a bottom view of an electrical connection according to a second embodiment of the invention;

FIG. 7 is a cross-sectional view illustrating an electrical connection before being soldered onto a circuit board according to a second embodiment of the invention;

FIG. 8 is a cross-sectional view illustrating an electrical connection after being soldered onto a circuit board according to a second embodiment of the invention;

FIG. 9 is a bottom view of an electrical connection according to a third embodiment of the invention;

FIG. 10 is a cross-sectional view illustrating an electrical connection before being soldered onto a circuit board according to a third embodiment of the invention;

FIG. 11 is a cross-sectional view illustrating an electrical connection after being soldered onto a circuit board according to third embodiment of the invention;

FIG. 12 is a bottom view of an electrical connection according to a fourth embodiment of the invention;

FIG. 13 is a cross-sectional view illustrating an electrical connection before being soldered onto a circuit board according to a fourth embodiment of the invention;

FIG. 14 is a cross-sectional view illustrating an electrical connection after being soldered onto a circuit board according to a fourth embodiment of the invention;

FIG. 15 is a cross-sectional view illustrating an electrical connection before being soldered onto a circuit board according to a fifth embodiment of the invention;

FIG. 16 is a cross-sectional view illustrating an electrical connection after being soldered onto a circuit board according to a fifth embodiment of the invention;

FIG. 17 is a schematic view illustrating an arrangement of soldering ends of terminals of an electrical connection according to a fifth embodiment of the invention;

is FIG. 18 is a schematic view illustrating an arrangement of soldering ends of terminals of an electrical connection taken from another angle of view according to a fifth embodiment of the invention;

FIG. 19 is a cross-sectional view illustrating an electrical connection before being soldered onto a circuit board according to a sixth embodiment of the invention;

FIG. 20 is a cross-sectional view illustrating an electrical connection after being soldered onto a circuit board according to a sixth embodiment of the invention;

FIG. 21 is a cross-sectional view illustrating an electrical connection before being soldered onto a circuit board according to a seventh embodiment of the invention;

FIG. 22 is a cross-sectional view illustrating an electrical connection after being soldered onto a circuit board according to a seventh embodiment of the invention; and

FIG. 23 is a cross-sectional view illustrating an electrical connection soldered onto a circuit board according to an eighth embodiment of the invention.

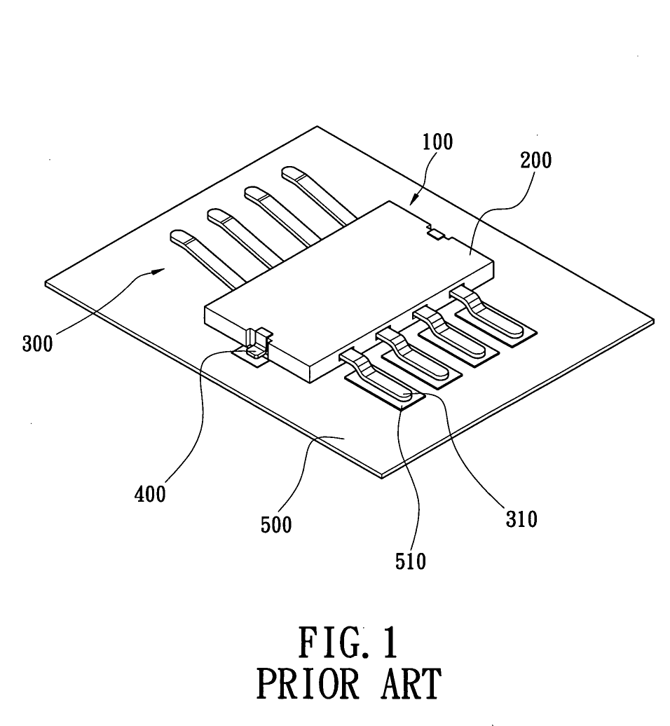

### DETAILED DESCRIPTION OF THE EMBODIMENTS

Wherever possible in the following description, like reference numerals will refer to like elements and parts unless otherwise illustrated.

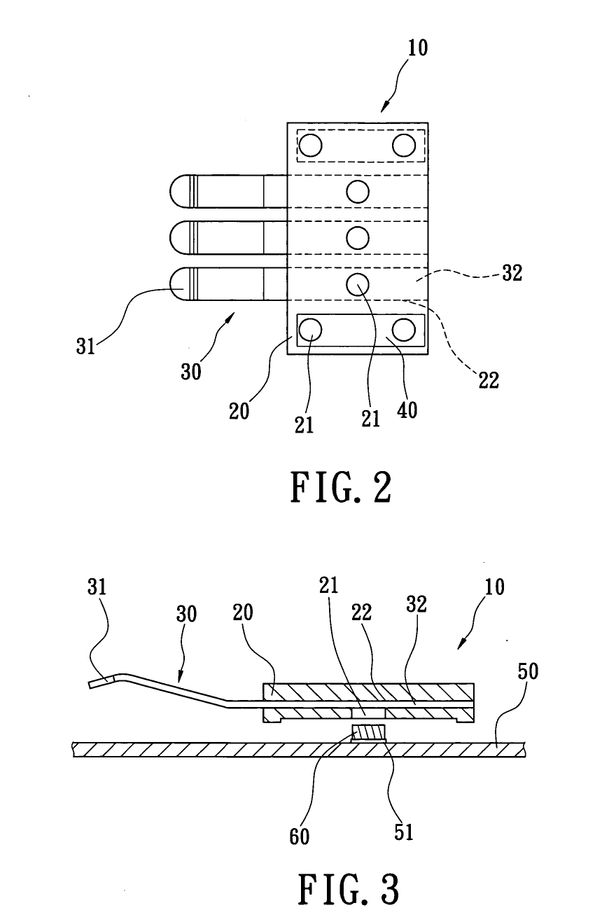

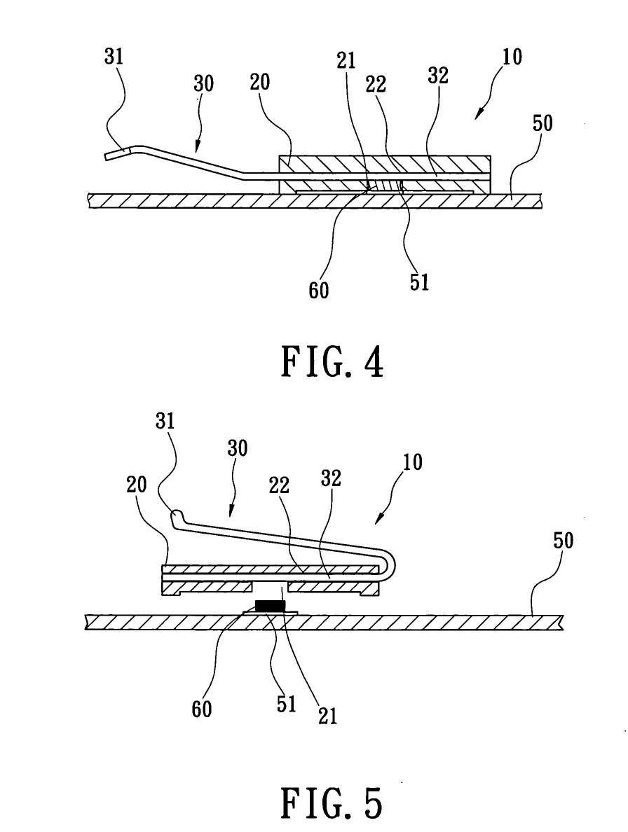

Referring to FIG. 2 to FIG. 4, which illustrate a first embodiment of the invention, a method of soldering an electrical connection includes forming plurality of terminals 30 on an insulating casing 20. The terminals 30 transversally extend through and are exposed by the insulating casing 20, thereby accomplishing an electrical connection 10. A plurality of slots 21 is formed on a bottom of the insulating casing 20 to communicate with the terminals 30, respectively.

The terminals 30 are formed by punching a metallic sheet. Each terminal 30 has a contact tip 31 and a fastening tip 32. The contact tip 31 is located outside the insulating casing 20 for attaching an external device (not shown) with which electrical connection is to be established. The fastening tip 32 is located inside the casing 20. The insulating casing 20 is formed with a plurality of slots 22 through which the terminals 30 penetrate. Alternately, the terminals 30 are fastened to the insulating casing 20 by implanting. The slots 21 respectively communicate with the fastening tips 32. A metallic fastener 40 is further embedded in the insulating casing 20 to firmly fasten the electrical connection 10 to the circuit board 50. Some of the slots 21 are in the bottom of the insulating casing 20 to communicate with the metal sheet 40.

A solder material 60 is then applied over electrical contacts 51 of a circuit board 50 in a manner to correspond to the slots 21 for bonding the electrical connection 10 to the circuit board 50.

Finally, the solder material 60 is melted by heating. The height of the solder material 60 applied over the electrical contacts increases due to the cohesion of the solder material 60 when the solder material 60 is melted, and the solder material 60 extends into the slots 21 for bonding terminals 30 to the metallic sheet 40.

The terminals 30 and the metallic sheet 40 do not necessarily contact the solder material 60 before being soldered. Since co-planarity problems are eliminated, soldering quality therefore is not affected. Furthermore, soldering is achieved by extending the solder material into the slots 21. Therefore, the problems of short circuits and soldering failure due to deformation of the terminals 30 are eliminated.

FIG. 5 is a cross-sectional view illustrating an electrical connection with another type of terminals 30 before being soldered onto a circuit board 50 according to a first embodiment of the invention.

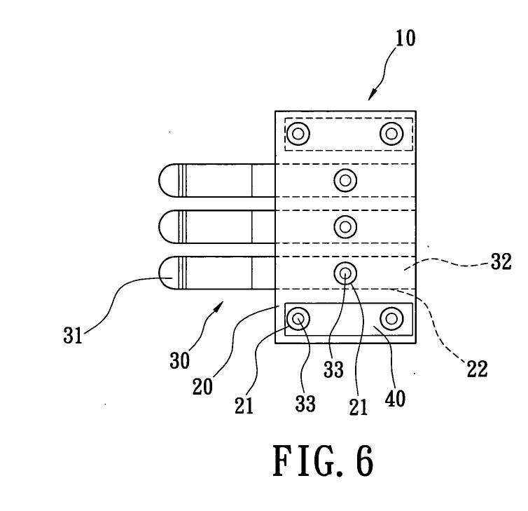

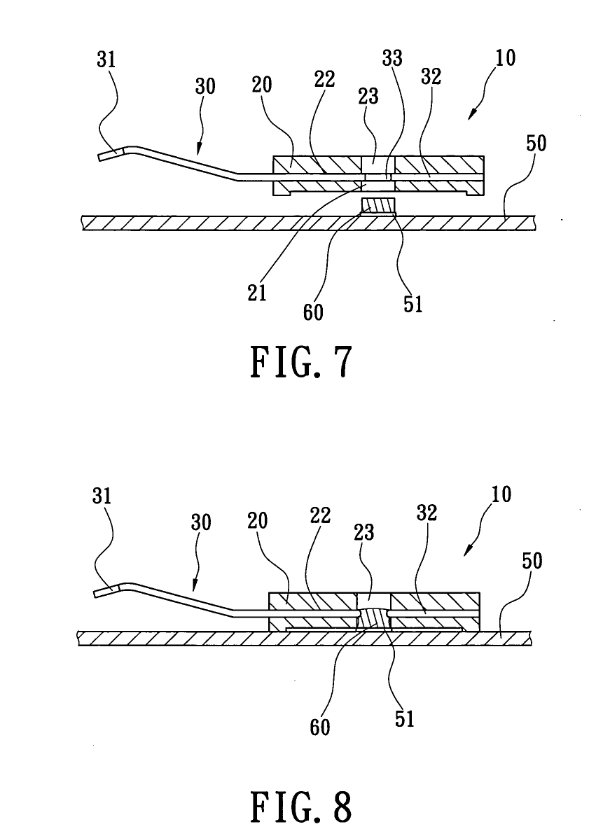

Referring to FIG. 6 to FIG. 8, which illustrate a second embodiment of the invention, a plurality of through holes 23 are formed in a top of the insulating casing 20 to correspond to the slots 21. The fastening tip 32 of each terminal 30 and the metallic sheet (not shown) respectively form a pinhole 33 to correspond to the through hole 23 and slot 21. The pinhole 33 is smaller than the through hole 23 and the slot 21. During soldering, the solder material 60 melts and flows through the pinholes 33 to the through holes 23. After the solder material 60 cools down, the solder material 60 bonds the fastening tip 32 of each terminal 30 and the metallic sheet onto the circuit board 50, thereby increasing the soldering strength.

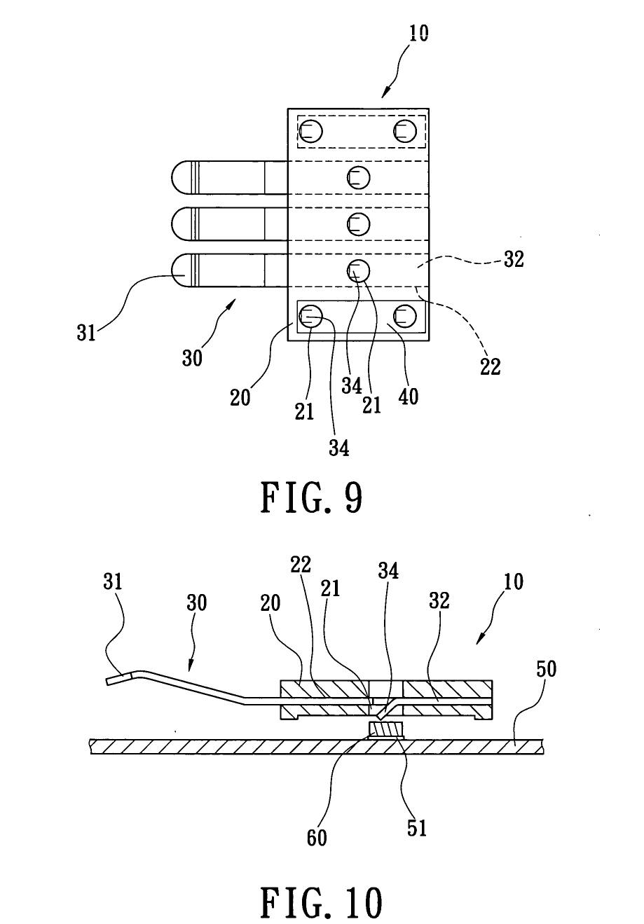

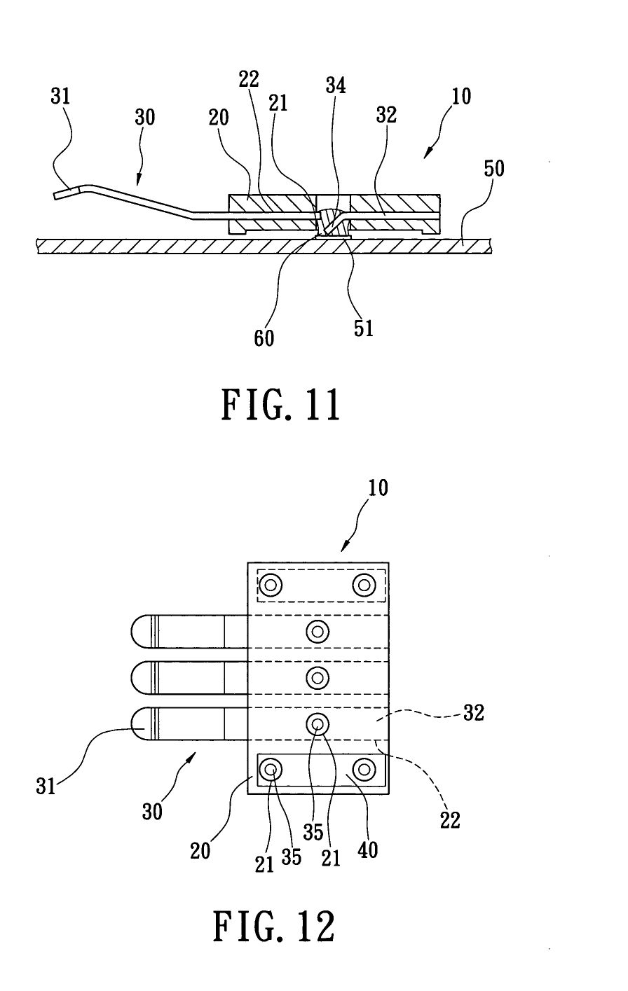

Referring to FIG. 9 to FIG. 11, which illustrate a third embodiment of the invention, a plurality of through holes 23 are formed in a top of the insulating casing 20 to correspond to slots 21. Soldering sheets 34 are respectively stamped on a fastening tip 32 of each terminal 30 and a metallic sheet (not shown) to correspond respectively to the through holes 23 and the slots 21. The soldering sheets 34 are bent toward the circuit board 50. During soldering, a solder material 60 melts and flows through the slots 21 to the through holes 23 so as to cover solder sheet 34. After the solder material 60 cools down, the bonding strength is increased.

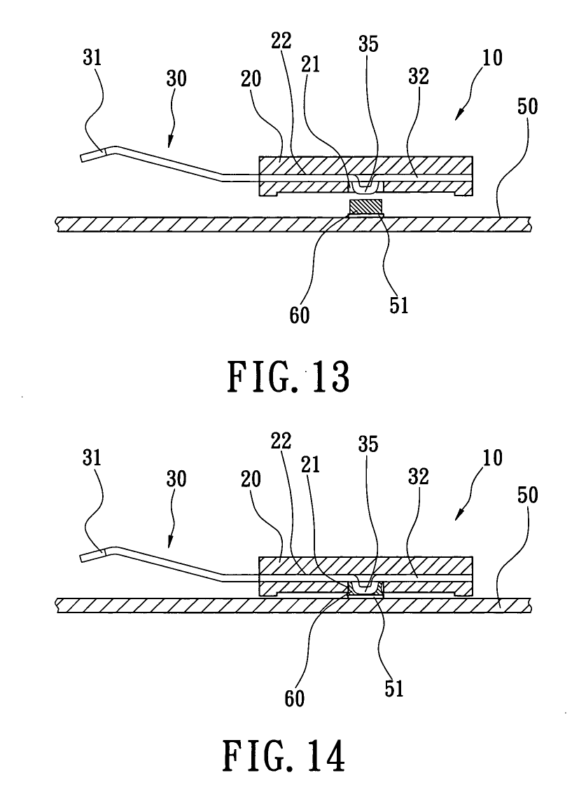

Referring to FIG. 12 to FIG. 14, which illustrate a fourth embodiment of the invention, bumps 35 are respectively formed on the fastening tip 32 of each terminal 30 and the metallic sheet (not shown) to correspond to the slots 21 of the insulating casing 20. The bumps 35 protrude toward a circuit board 50. The bumps 35 increase a soldering area for the solder material 60, which increases the soldering strength.

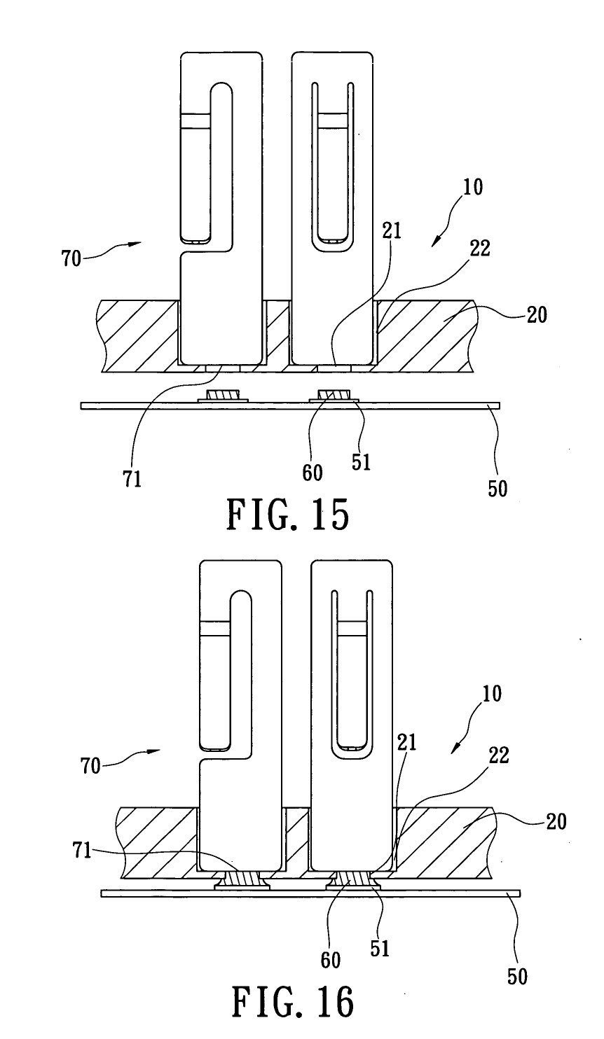

FIG. 15 and FIG. 16 illustrate a method of soldering an electrical connection according to a fifth embodiment of the invention. In step 1, terminals 70 extend lengthwise through an insulating casing 20. The slots 21 are formed in the bottom of the insulating casing 20 to correspond to an end of each terminal 70. Each terminal 70 has a width larger than a diameter of each slot 21.

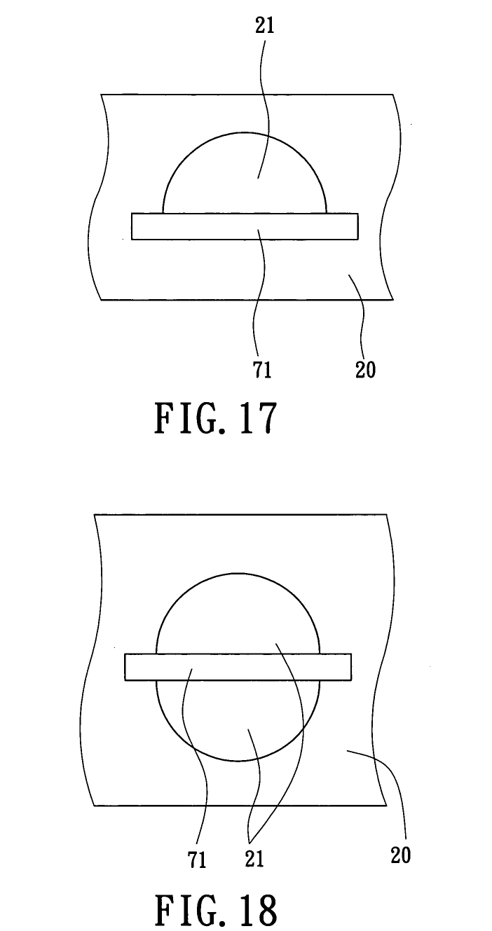

Referring to FIG. 17 and FIG. 18, the end of each terminal 70 aligns with a central portion or peripheral portion of a corresponding slot 21.

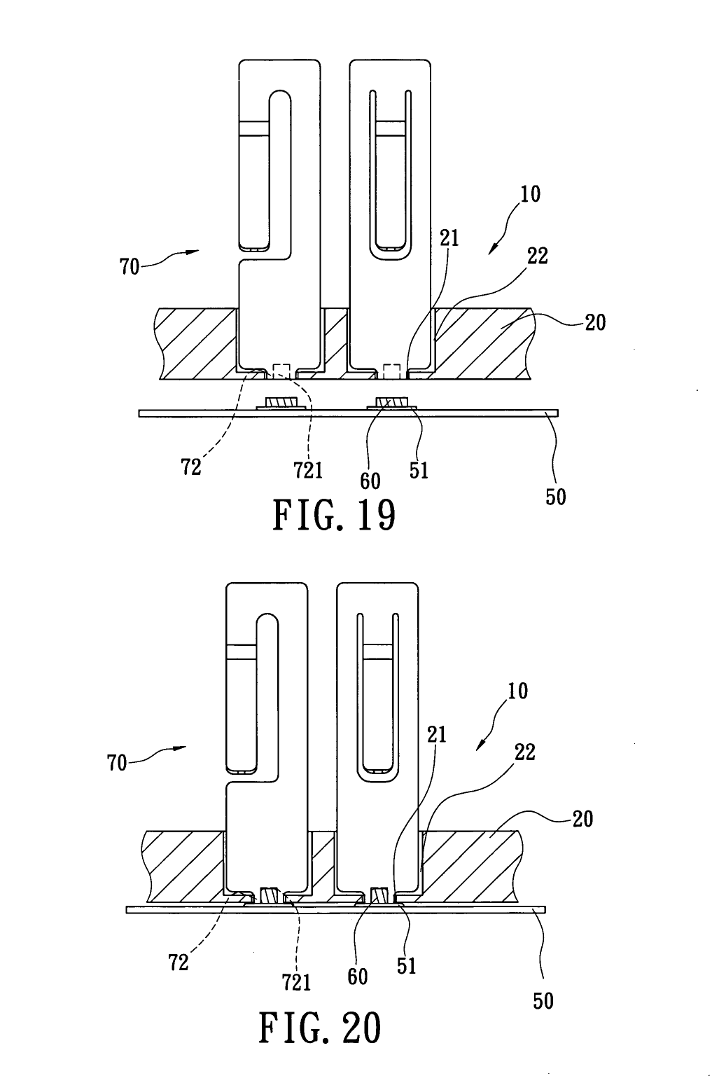

Referring to FIG. 19 and FIG. 20, which illustrate a sixth embodiment of the invention, an end of each terminal 70 is formed with a protruding part 72 for insertion in each slot 21 of the insulating casing 20. The protruding part 72 has a notch 721 for accommodating the solder material 60 to bond the terminals 70 and increase the soldering strength.

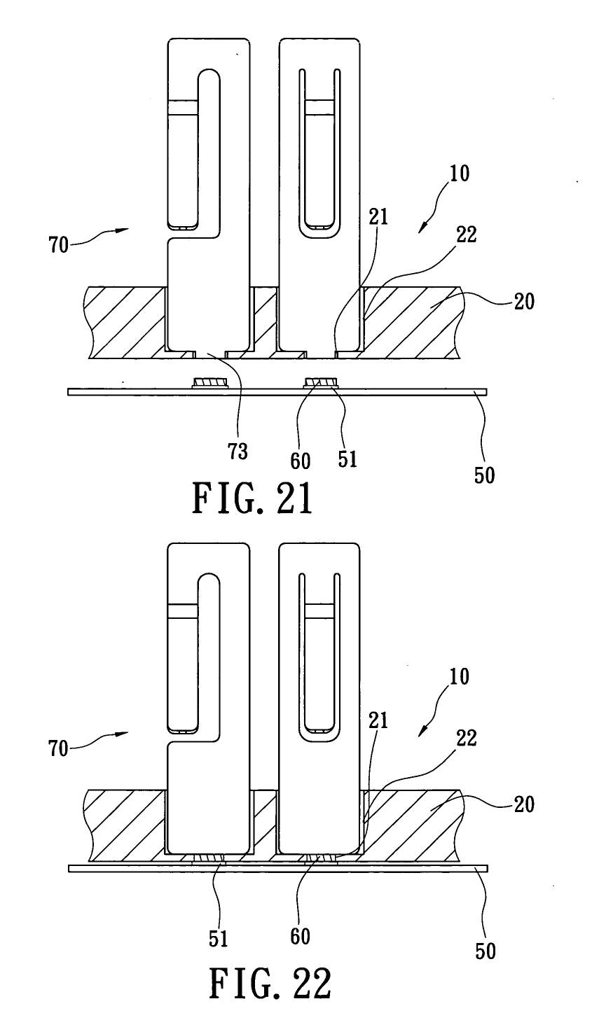

Referring to FIG. 21 and FIG. 22, which illustrate a seventh embodiment of the invention, a protruding part 73 is formed on an end of each terminal 70 for insertion in each slot 21 of the insulating casing 20. The protruding part 73 has a width smaller than a diameter of each slot 21. The solder material 60 flows in the slots 21 after being melted to cover the protruding part 73 and increase the soldering strength.

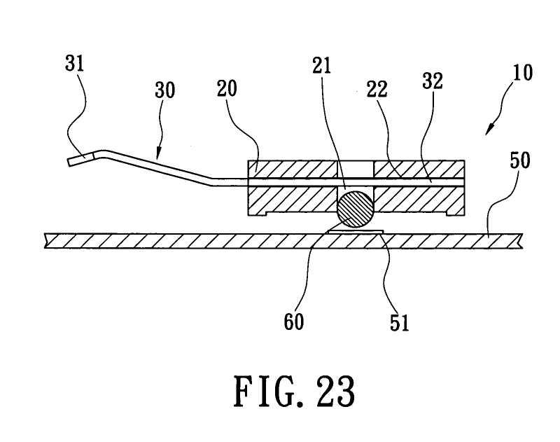

Referring to FIG. 23, which illustrates an eighth embodiment of the invention, a method of soldering an electrical connection includes:
1) forming a plurality of terminals 30 on an insulating casing 20 to accomplish an electrical connection 10, a plurality of slots 21 being formed in a bottom of the insulating casing 20 to communicate respectively with ends of the terminals 30;
2) applying a solder material 60 along a periphery of each slot 21 for bonding the electrical connection 10 to the circuit board 50, the solder material 60 corresponding to electrical contacts 51 of the circuit board 50; and
3) melting the solder material 60 by heating, the height of the solder material 60 increasing due to its cohesion so that the solder material 60 flows into the slots 21, thereby bonding the terminals 30 to the electrical contacts 51 of the circuit board 50.

As described above, the method of soldering the electrical connection provides the following advantages:
1. The terminals and the metallic sheet need not contact the solder material before being soldered. Since no problem of co-planarity occurs, soldering quality is not affected. Furthermore, soldering is achieved by extending the solder material into the slots. Therefore, the problems of short circuit and soldering failure due to deformation of the terminals are eliminated.
2. With terminals transversally extending through the insulating casing, the formation of pinholes, soldering sheet and pumps increases the soldering strength.
3. With terminals lengthwise extending through the insulating casing, the formation of the notch and protruding parts increases the soldering strength.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A method of soldering an electrical connection, comprising:
1) forming a plurality of terminals on an insulating casing, the terminals transversally extending through and being exposed by the insulating casing, a plurality of first slots being formed in a bottom of the insulating casing to communicate respectively with the terminals;
2) applying a solder material over electrical contacts of a circuit board for bonding the electrical connection to the circuit board, wherein the first slots in the bottom of the insulating casing correspond to the solder material; and
3) melting the solder material by heating, wherein a height of the solder material increases due to a cohesion effect and the solder material extends into the first slots and bonds to the terminals.

2. The method of claim 1, wherein in step 1) each terminal has a contact tip and a fastening tip, the contact tip being located outside the insulating casing, the fastening tip being located inside the casing, and one first slot communicating with one fastening tip.

3. The method of claim 1, wherein in step 1) the insulating casing is further formed with a plurality of second slots through which the terminals penetrate.

4. The method of claim 1, wherein in step 1) the terminals are fastened to the insulating casing by implanting.

5. The method of claim 1, wherein in step 1) a metal sheet is further embedded in the insulating casing to communicate with some of the first slots on the insulating casing, and in step 3) the solder material is melted by heating to bond to the metallic sheet.

6. The method of claim 1, wherein in step 1) a plurality of through holes are formed in a top of the insulating casing to correspond respectively to the first slots, the fastening tip of each terminal being formed with a pinhole to correspond to one respective through hole and first slot, the pinhole being smaller than the through hole and the first slot, and in step 3) the solder material flowing in the through holes via the pinholes after being melted.

7. The method of claim 1, wherein a plurality of through holes are formed in a top of the insulating casing to correspond to the first slots, a plurality of soldering sheets being respectively stamped on a fastening tip of each terminal to correspond to the through holes and the first slots, the soldering sheets being bent toward the circuit board, and in step 3) the solder material flowing through the first slots to the through holes after being melted so as to cover the soldering sheets.

8. The method of claim 1, wherein in step 1) a plurality of bumps are respectively formed on the fastening tips of the terminals to correspond to the first slots of the insulating casing, and the bumps protrude toward the circuit board.

9. A method of soldering an electrical connection, comprising:
1) forming a plurality of terminals on an insulating casing, the terminals extending lengthwise through the insulating casing, a plurality of first slots being formed in a bottom of the insulating casing to communicate respectively with ends of the terminals;
2) applying a solder material over electrical contacts of a circuit board for bonding the electrical connection to the circuit board, wherein the first slots in the bottom of the insulating casing correspond to the solder material; and
3) melting the solder material by heating, wherein a height of the solder material increases due to a cohesion effect so as to extend into the first slots and bond the terminals.

10. The method of claim 9, wherein in step 1) each terminal has a contact tip and a fastening tip, the contact tip being located outside the insulating casing, the fastening tip being located inside the casing, and the first slots respectively communicating with the fastening tips.

11. The method of claim 9, wherein in step 1) the insulating casing is further formed with a plurality of second slots through which the terminals penetrate.

12. The method of claim 9, wherein in step 1) the terminals are fastened to the insulating casing by implanting.

13. The method of claim 9, wherein in step 1) a metal sheet is further embedded in the insulating casing and communicates with some first slots on the insulating casing, and in step 3) the solder material is melted by heating to bond to the metallic sheet.

14. The method of claim 9, wherein in step 1) an end of each terminal corresponds to one first slot of the insulating casing, a width of each terminal being larger than a diameter of a corresponding first slot.

15. The method of claim 9, wherein in step 1) an end of each terminal aligns with a central portion of a corresponding first slot.

16. The method of claim 9, wherein in step 1) an end of each terminal aligns with a central portion of a corresponding first slot.

17. The method of claim 9, wherein an end of each terminal is formed with a protruding part for insertion in each first slot of the insulating casing, the protruding part having a notch therein for accommodating a solder material to bond the terminals.

18. The method of claim 9, wherein a protruding part is formed on an end of each terminal for insertion in each first slot of the insulting casing, the protruding part having a width smaller than a diameter of each slot, and in step 3) a solder material flowing in the first slots after being melted to cover the protruding part.

19. A method of soldering an electrical connection, comprising:
1) forming a plurality of terminals on an insulating casing to accomplish an electrical connection, wherein a plurality of slots is formed in a bottom of the insulating casing to communicate respectively with the terminals.
2) applying a solder material along a periphery of the slots to correspond to electrical contacts of a circuit board for bonding the electrical connection to the circuit board.
3) melting the solder material by heating, wherein the solder material increases in height to extend into the slots by cohesion effect, thereby bonding the terminals to the electrical contacts of the circuit board.
